(19) United States
(12) Patent Application Publication
(10) Pub. No.: US 2010/0169069 A1
(43) Pub. Date: Jul. 1, 2010

(54) Composite device emulation

(76) Inventors: Nimrod Diamant, Kfar-Saba (IL); Kar Leong Wong, Perak (MY); Karthi Vadivelu, Folsom, CA (US)

Correspondence Address: INTEL CORPORATION;c/o CPA Global, P.O. BOX 52050, MINNEAPOLIS, MN, 55402, US

(21) Appl. No.: 12/317,848

(22) Filed: Dec. 29, 2008

(51) Int. Cl. G06F 9/455

(52) U.S. Cl. 703/24

(57) ABSTRACT

In one embodiment, an apparatus provides a plurality of endpoints, each endpoint corresponding to a function of an emulated device, having at least one buffer to store emulation information corresponding to the emulated device; and logic to perform low level emulation of at least one of the functions corresponding to the plurality of endpoints

### FIELD

Embodiments of this invention relate to composite device emulation.

### BACKGROUND

Typical remote management systems today rely on special remote connection application software running on a PC (personal computer), as well as on the operating system to be stable and running for the remote management session to be alive. With the introduction of hardware-assisted remote management technology that works even if the PC is down or off, it reduces these dependencies and allows more sophisticated remote management capabilities not available in previous generation PCs or software-only solutions.

For example, U.S. patent application Ser. No. 11/027,754 titled “Virtual IDE Interface and Protocol for Use in IDE Redirection Communication” describes a mechanism that, for example, can boot a system using a remote IDE storage device such as an IDE hard disk or CD-ROM. As another example, some server systems have discrete, stand-alone USB products having re-direction functionality that supports a predefined set of emulated devices.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a system in accordance with embodiments of the invention.

FIG. 2 illustrates a data emulator according to an embodiment of the invention.

FIG. 3 illustrates a method in accordance with embodiments of the invention.

### DETAILED DESCRIPTION

Examples described below are for illustrative purposes only, and are in no way intended to limit embodiments of the invention. Thus, where examples are described in detail, or where one or more examples are provided, it should be understood that the examples are not to be construed as exhaustive, and are not to be limited to embodiments of the invention to the examples described and/or illustrated.

In one example embodiment, remote management may be implemented by redirecting device functionality (such as keyboard and mouse, and data transfer from storage devices) from a remote management machine to a local managed machine. By emulating these devices, a remote management machine appears as an OS-independent device on a local managed machine through a hardware-based communications channel. Emulation of the device enables the local managed machine to be managed remotely. For example, remote repair, and support of a system that has become unstable, or that its local user can not fix may all be handled remotely. In an embodiment, device emulation may be implemented using a USB (Universal Serial Bus) protocol which supports various types of devices including USB CD (compact disc) drive, USB floppy, USB disk on key, USB keyboard, and USB mouse, as well as plug and play and system booting. Accompanied with the video re-direction, device emulation can form the KVM (Keyboard Video Mouse) structure over LAN (local area network) connection and emulate a composite USB device on the local managed machine. USB specifications for various versions are available from USB-IF (USB Implementers Forum), located 3855 SW 153^{rd} Drive, Beaverton, Oreg., 97006. Hereinafter, a remote management machine is referred to as “management console”, and a local managed machine is referred to as “system”.

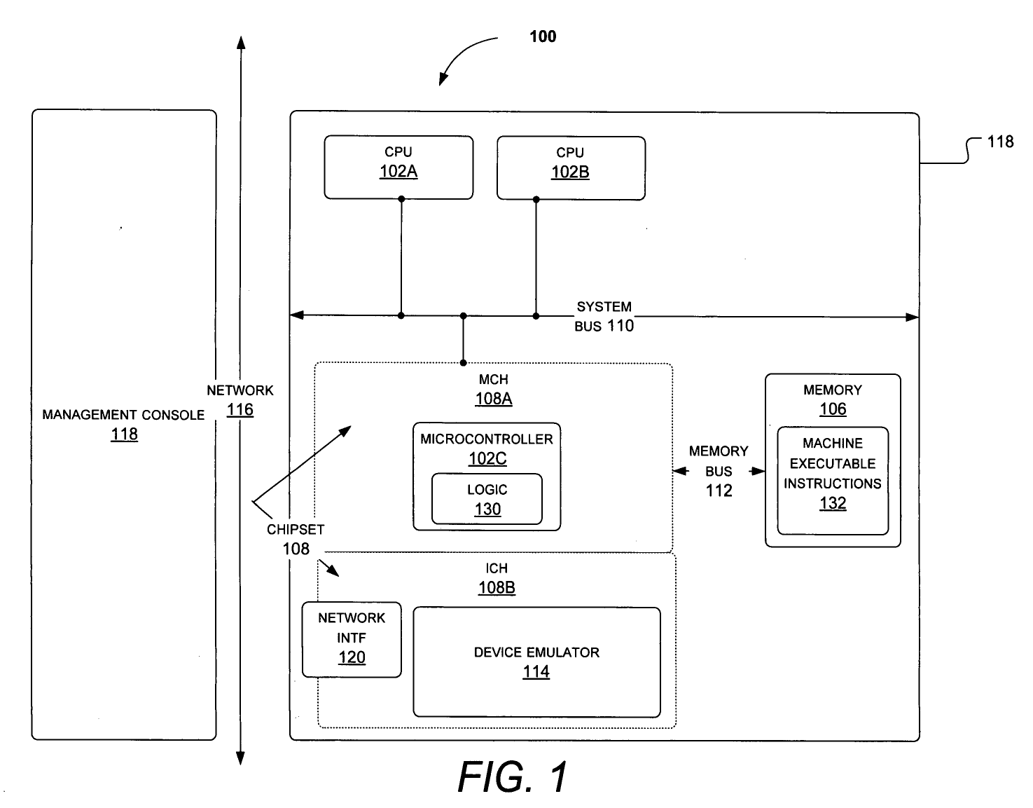

FIG. 1 is a block diagram that illustrates a computing system 100 according to an embodiment. In some embodiments, computing system 100 may comprise at least one processor 102A, 102B. A “processor” as discussed herein relates to any combination of hardware and software resources for accomplishing computational tasks. For example, a processor may comprise a central processing unit (CPU), e.g., 102A, 102B to execute machine-readable instructions for processing data according to a predefined instruction set or to house firmware. A processor may comprise a multi-core processor having a plurality of processing cores. A processor may alternatively refer to a processing core that may be comprised in the multi-core processor, where an operating system may perceive the processing core as a discrete processor with a full set of execution resources. These processors may be high performance for executing sophisticated application software. Furthermore, the system 100 does not need to be in an active power state for the processors 102A, 102B to function. Other possibilities exist.

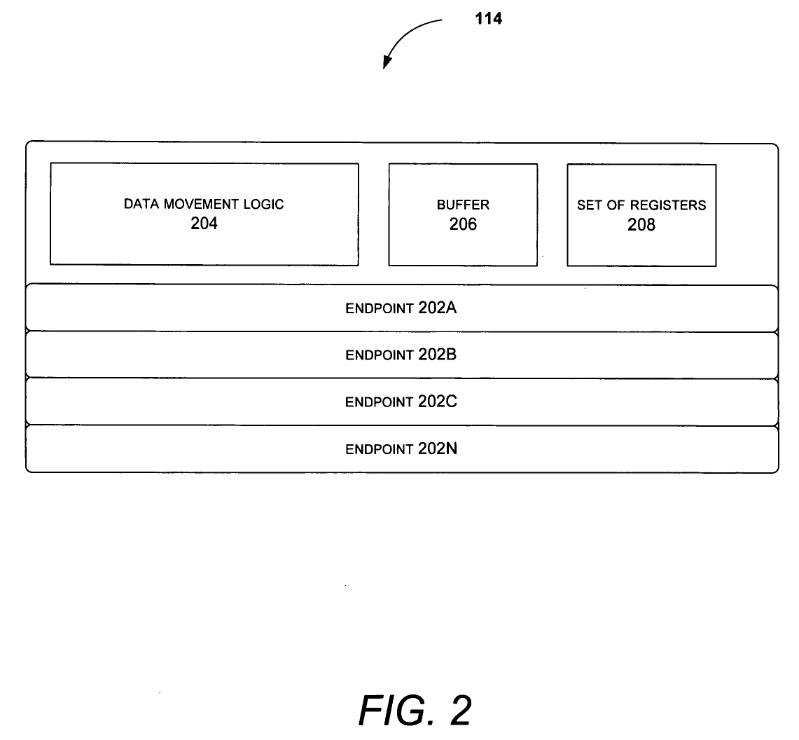

System 100 may comprise at least one or more additional processors 102C. In an embodiment, one or more additional processors may comprise microcontroller 102C. In an embodiment, microcontroller 102C may comprise a manageability engine that is part of Intel® Active Management Technology, available from Intel® Corporation, 2200 Mission College Blvd., Santa Clara, Calif. 95054. A manageability engine may implement various services on behalf of applications in system 100. Manageability engine may run on auxiliary power, therefore being available in all power states. In an embodiment, microcontroller 102C may be embedded on chipset 108, specifically MCH 108A, although embodiments of the invention are not limited by this. In FIG. 2, processor 102C is shown to reside on chipset 108. In other embodiments, processor 102C may instead be integrated with one or more CPU's 102A, 102B. As used throughout, microcontroller 102C may refer to a specific implementation of processor; however, embodiments of the invention are not limited in this respect, and it is to be understood that microcontroller 102C may in other embodiments generically refer to one of a plurality of processors in system 100.

System 100 may additionally comprise memory 106. Memory 106 may store machine-executable instructions 132 that are capable of being executed, and/or data capable of being accessed, operated upon, and/or manipulated. “Machine-executable” instructions as referred to herein relate to expressions which may be understood by one or more machines for performing one or more logical operations. For example, machine-executable instructions 132 may comprise instructions which are interpretable by a processor compiler for executing one or more operations on one or more data objects. However, this is merely an example of machine-executable instructions and embodiments of the present invention are not limited in this respect. Memory 106 may, for example, comprise read only, mass storage, random access computer-accessible memory, non-volatile memory, and/or one or more other types of machine-accessible memories. In an embodiment, memory 106 may be partitioned in accordance with, for example, UMA (Unified Memory Architecture), such that portions of memory 106 may be reserved for and used by microcontroller 102C.

Logic 130 may be comprised on or within any part of system 100 (e.g., microcontroller 102C). Logic 130 may comprise hardware, software, or a combination of hardware and software (e.g., firmware). For example, logic 130 may comprise circuitry (i.e., one or more circuits), to perform operations described herein. For example, logic 130 may comprise one or more digital circuits, one or more analog circuits, one or more state machines, programmable logic, and/or one or more ASICs (Application-Specific Integrated Circuits). Logic 130 may be hardwired to perform the one or more operations. Alternatively or additionally, logic 130 may be embodied in machine-executable instructions 132 stored in a memory, such as memory 106, to perform these operations. Alternatively or additionally, logic 130 may be embodied in firmware. Logic may be comprised in various components of system 100. Logic 130 may be used to perform various functions by various components as described herein.

Chipset 108 may comprise a host bridge/hub system that may couple each of CPUs 102A, 102B, and memory 106 to each other. Chipset 108 may comprise one or more integrated circuit chips, such as those selected from integrated circuit chipsets commercially available from Intel® Corporation (e.g., graphics, memory, graphics/memory, and I/O controller hub chipsets), although other one or more integrated circuit chips may also, or alternatively, be used. Chipset 108 may communicate with memory 106 via memory bus 112 and with processors 102A, 102B via system bus 110. In alternative embodiments, processors 102A, 102B and memory 106 may be coupled directly to system bus 110, rather than via chipset 108.

According to an embodiment, chipset 108 may comprise a memory control hub (MCH) 108A coupled to memory 106, and an input/output control hub (ICH) 108B, although embodiments of the invention are not limited by this. For example, MCH 108A functionality may be integrated, in whole or in part, onto CPU, and ICH 108B may be a standalone chipset. As another example, in some embodiments, system 100 need not comprise chipset 108, and some or all of chipset functionality may be integrated onto the processor die. MCH 108A may, for example comprise memory and graphics control. ICH 108B may, for example, comprise input/output control, including integrated network interface 120 to enable system 100 to communicate over network 116 with remote systems, for example, management console 118. In another embodiment, the network interface can be a standard-alone network interface card (NIC) attached to ICH 108B.

System may additionally comprise device emulator 114. Device emulator 114 may emulate one or more devices (“emulated devices”) as described in various embodiments herein. An “emulated device”, as used herein, refers to a device that is to be emulated in system 100. The emulated device may represent a physical or a virtual device. Furthermore, the physical or virtual device may be a device on system 100 or management console 118. For example, in an embodiment, emulated device is not physically located on system 100. In another embodiment, emulated device may not exist on management console 118 but may be virtually emulated by device emulator 114 for the intended functionality.

In an embodiment, device emulator 114 may be embedded in chipset 108, specifically, for example, 108B, through an internal port of a host controller. However, again, embodiments of the invention are not limited by this, and device emulator 114 may instead be connected to chipset 108 through an external port of the host controller. Again, other possibilities may exist. In embodiments, a host controller enables communication between the devices it supports (e.g., USB) and the operating system.

In an embodiment of the invention, device emulator 114 may emulate a device by mimicking device functionality (using command and data controls sent to and received from management console 118) in system 100 so that the device emulator may appear to system 100 as a physical device. Device emulator 114 may correspond to a single function device, or to a multi-function composite device.

In an embodiment, microcontroller 102 may be located on MCH 108A, and device emulator 114 may be located on ICH 108B. In an alternative embodiment, both microcontroller 102 and device emulator 114 may be located on the same integrated circuit. Embodiments of the invention, however, are not limited in these respects.

Processors 102A, 102B, 102C memory 106, busses 110, 112, and certain other components described above may be comprised in a single circuit board, such as, for example, a system motherboard 118, or even integrated on the same silicon, but embodiments of the invention are not limited in this respect.

FIG. 2 provides an expanded illustration of a device emulator. Device emulator 114 may comprise one or more functions. In the case of a USB device emulator, these functions are implemented as USB endpoints. As used herein, an endpoint shall refer generally to an implementation (e.g., hardware, software, firmware) of a function on a device emulator, and is not limited to USB implementations.

Device emulator 114 may comprise at least one endpoint, although a plurality of endpoints 202A, 202B, 202C, . . . , 202N are illustrated. Each endpoint 202A, 202B, 202C, . . . , 202N may correspond to a function of an emulated device. Endpoints 202A, 202B, 202C, . . . , 202N may also maintain statuses (including completion information). For example, for transactions to the host processor 102A, 102B, an endpoint 202A, 202B, 202C, . . . , 202N may collect host-generated ACKs (acknowledgements), and for transactions from the host processor 102A, 102B, it may generate ACKs to the host processor 102A, 102B.

Each endpoint 202A, 202B, 202C, . . . , 202N may comprise at least one buffer 206 (shown as a single shared buffer used by all endpoints). Furthermore, each endpoint 202A, 202B, 202C may additionally comprise at least one set of registers 208 (again, shown as a single shared set of registers used by all endpoints). The buffer(s) 206 may store emulation information (described below) for the corresponding device, and may also receive completion information from the host controller.

The at least one set of registers 208 may be used by, for example, microcontroller 102C to control the one or more endpoints 202A, 202B, 202C, . . . , 202N. Microcontroller 102C may enable endpoints 202A, 202B, 202C, . . . , 202N to emulate devices by programming registers 208 associated with the endpoints 202A, 202B, 202C, . . . , 202N. Microcontroller 102C may furthermore enable endpoints 202A, 202B, 202C, . . . , 202N and disable endpoints 202A, 202B, 202C, . . . , 202N to emulate different device functionality, depending on the number of endpoints required. In an embodiment, once endpoints 202A, 202B, 202C, . . . , 202N are enabled, device emulator 114 may be coupled to host controller through an internal port of, for example, ICH 108B.

As mentioned above, device emulator 114 may function as a single function device, or as a multi-function device. In this respect, device emulator 114 may comprise a single endpoint (e.g., one of 202A, 202B, 202C, . . . , 202N) when it functions as a single function device, and may comprise a plurality of endpoints 202A, 202B, 202C, . . . , 202N when it functions as a multi-function composite device. In the context of USB device emulation, for example, device emulator 114 may represent a composite USB device having multiple functions, and each function may be handled by endpoints 202A, 202B, 202C, . . . , 202N of device emulator 114. In an embodiment, a device function may be referred to as an interface.

Device emulator 114 may additionally comprise data movement logic 204 to move emulation information (described below) to and from buffer 206. As used herein, data movement logic shall refer to specialized functionality or a specialized module for transferring data. A DMA (direct memory access) engine is an example of data movement logic.

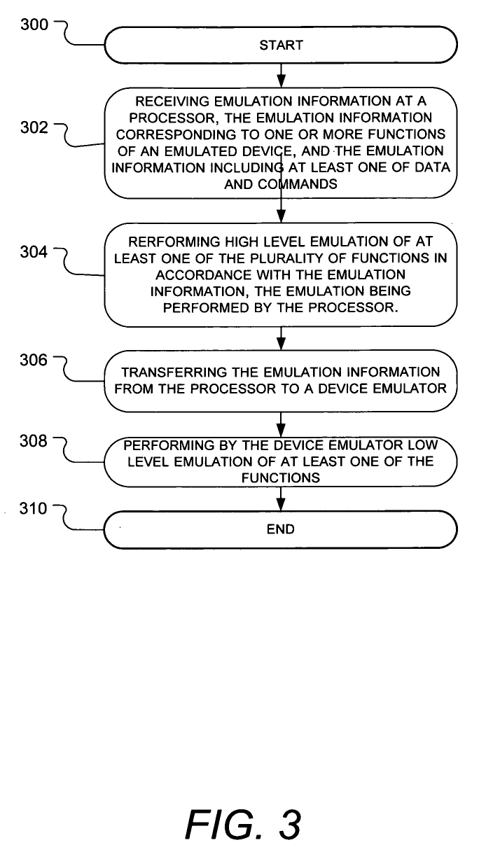

FIG. 3 illustrates a method in accordance with an embodiment of the invention. The method of FIG. 3 begins at block 300 and continues to block 302 where the method may comprise receiving emulation information at a processor, the emulation information corresponding to one or more functions of an emulated device, and the emulation information including at least one of data and commands.

As used herein, “emulation information” refers to commands or to data corresponding to an emulated device that may be sent to and/or received from management console 118. Emulation information may include emulation commands and/or data.

In an embodiment, emulation information may be transmitted externally from, for example, management console 118. However, embodiments of the invention are not limited in this respect, and some embodiments, emulation information may be transmitted from one or more components of system 100 itself. In an embodiment, an event may occur, which triggers communication of emulation information between management console 118 and system 100. The event may be initiated from management console 118 or from system 100. For example, the event may be triggered where management console 118 needs to remotely install an operating system on system 100 (in which case management console 118 may initiate emulation of a storage device). Or, management console 118 may need to remotely control system 100 using a keyboard (in which case management console 118 may initiate emulation of a keyboard).

System 100 may receive emulation information at network 116 through a network interface, although embodiments of the invention are not limited in this respect. Emulation information may be received at microcontroller 102C of system 100, and stored in a memory reserved for microcontroller 102C, such as memory 106 or in another memory (not shown) dedicated to microcontroller 102C.

In an embodiment, the emulation information received at system 100 may be associated with a device having a first protocol. Emulation information may then be converted to a second protocol. The first and second protocols may be the same protocol, or they may be different protocols. In an embodiment, the second protocol (associated with transmitting device) may be any protocol, and the first protocol (associated with system 100) is USB (Universal Serial Bus), although embodiments of the invention are not limited to this standard. Although embodiments of the invention are not limited to a particular version of USB, the current version of the USB protocol is defined in Universal Serial Bus Specification, Revision 2.0, dated Apr. 27, 2000. USB offers some conveniences. For example, since USB devices are supported at pre-operating system boot time, emulated USB devices can be dynamically plugged into or unplugged from a running system. Also, a standard USB device does not involve special host driver development. However, embodiments of the invention are not limited in this respect.

At block 304, the method may comprise performing high level emulation of at least one of the plurality of functions in accordance with the emulation information, the emulation being performed by the processor.

In one embodiment, microcontroller 102C may manage high level emulation of the emulated device, and device emulator 114 may manage low level emulation of the emulated device in, e.g., hardware circuitry of device emulator 114. In this embodiment, microcontroller 102C may also manage one or more network protocols to enable communication with one or more management consoles, e.g., management console 118, across network 116. In another embodiment, both high level and low level emulation of the emulated device may be implemented in, e.g., hardware circuitry of device emulator 114, and microcontroller 102C may perform just data transfer to device emulator 114.

High level emulation refers to emulation of an emulated device in a manner that makes the microcontroller 102C or device emulator 114 behave like the emulated device at the session management level. Low level emulation refers to emulation of an emulated device at a protocol level.

This high level emulation may be specific to a device (or function/interface specific where the emulated device is a composite device of multiple functions). Similarly the data that is moved to/from endpoints is function/interface specific and is part of the function/interface protocol. For example, where device emulator 125 emulates a USB composite device having multiple functions, the microcontroller 102C may fit or extract the emulation data to/from a USB transaction packet, such as OUT transaction for data from device emulator 114 to microcontroller 102C (and later to network), IN transaction for data from microcontroller 102C (from network) to device emulator 114, or SETUP transaction which sends and return control/status information.

At block 306 the method may comprise transferring the emulation information from the processor to a device emulator. To transfer emulation information to device emulator 114, emulation information may be moved from memory, e.g., memory 106, to a buffer 206 associated with the corresponding endpoint 202A, 202B, 202C, . . . , 202N. In an embodiment, data movement logic 204 may be used to do this. However, in embodiments, for example, where the microcontroller 102C and device emulator 114 may be located on the same die, data movement logic does not need to be used. For example, microcontroller 102C may be used to carry out the data transfer to/from the endpoint 202A, 202B, 202C, . . . , 202N.

The format of the emulation information stored in buffer 206 can be as raw as the emulation information transfer over the network such that it relies on sophisticated hardware, e.g., in device emulator 114 to perform protocol conversion, or the microcontroller 102C can handle the protocol conversion through executable code.

At block 308, the method may comprise performing by the device emulator low level emulation of at least one of the functions. Device emulator 114 may then handle the low level protocol. In an embodiment, as an example, the low level protocol may be USB link layer transfer protocol such as IN/OUT/SETUP transaction sequencing, retry of a transaction, address assignment, and so forth.

For example of a USB keyboard emulation, device emulator 114 may receive an inquiry for a keystroke interrupt occurrence in an emulated USB keyboard through an IN transaction. Device emulator 114 may retry the IN transaction, and at the same time forward the request of IN transaction data to microcontroller 102C. Microcontroller 102C will then prepare the status for the interrupt inquiry in the buffer 206 of the device emulator 114. And when the host controller later retries for the IN transaction again, device emulator 114 can deliver the data for the IN transaction to the host controller from the buffer 206. Later the host controller can request for the actual keystroke data through the similar IN transaction protocol.

If device emulator 114 is sophisticated hardware, then handling the low level protocol is in addition to handling the high level protocol. For example, device emulator 114 may understand the command being transferred through the low level protocol and respond to it without support (or with minimum support) from microcontroller 102C. Device emulator 114 hardware may even convert to/from the final network packet format to offload the microcontroller 102C tasks.

The method may end at block 310.

In operation, command and/or data transmitted by management console 118 may appear to system 100 as command and/or data transmitted by a physical or virtual emulated device (or combination of both).

For example, an image file transmitted by management console 118 may appear to system 100 as an image file transmitted by a physical or virtual CD-ROM (the “emulated device”) coupled to system 100; or keyboard strokes transmitted by management console 118 may appear to system 100 as identical keyboard strokes transmitted by the emulated keyboard coupled to system 100.

As an example, if an operating system needs to be installed, and such installation would typically be performed using a storage device such as a CD-ROM (Compact Disc-Read Only Memory), device emulator 114 may emulate CD-ROM functionality (physical and/or virtual) by a CD-ROM image file. As another example, to avoid the need for a system administrator to be physically present to implement fixes or updates to system 100, for example, management console 118 may administer the fixes/updates by sending commands/data to system 100 that enable device emulator 114 to emulate keyboard strokes or mouse movements on system 100.

For example, device emulator 114 may (remotely) emulate a storage device that is physically or virtually on management console 118. In this example, management console 118 may send a command to emulate the insertion or removal of the emulated storage device. Once the emulated storage device appears to system 100 as being attached, the OS (operating system) on system 100 can access the emulated storage device like it is physically there. Storage related commands (such as a read command or a write command) may then be sent from the OS to device emulator 114, and forwarded to management console 118.

For example, in response to a storage read command, management console 118 may send storage data to device emulator 114, and then returned by device emulator 114 back to the OS. For example, in response to a write command, the OS may send storage data to device emulator 114, and device emulator 114 may then forward storage data to the management console. Management console 118 may additionally send a status response to device emulator 114 at the end of the commands, which may then be returned by device emulator 114 to OS.

Keyboard emulation is another example where management console 118 may send a command to emulate insertion or removal of a keyboard. Management console 118 may send keyboard data messages (in the form of, e.g., keystrokes) to device emulator 114. Device emulator 114 may send to management console 118 status messages such as LED on/off state.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

What is claimed is:

1. An apparatus, comprising:
a plurality of endpoints, each endpoint:
corresponding to a function of an emulated device;
having at least one buffer to store emulation information corresponding to the emulated device; and
logic to perform low level emulation of at least one of the functions corresponding to the plurality of endpoints.

2. The apparatus of claim 1, wherein the device emulator is internally coupled to an integrated circuit.

3. The apparatus of claim 1, wherein each endpoint retrieves emulation information corresponding to the emulated device from a memory, and the device emulator additionally comprises data movement logic to move the emulation information from the memory to the at least one buffer.

4. The apparatus of claim 1, additionally comprising logic to perform high level emulation of at least one of the functions corresponding to the plurality of endpoints.

5. The apparatus of claim 1, each endpoint additionally comprising at least one set of registers used to enable and disable the each endpoint.

6. A system, comprising:
a microcontroller to:
receive emulation information corresponding to one or more functions of an emulated device, the emulation information including at least one of data and commands; and
perform high level emulation of the plurality of functions in accordance with the emulation information; and
a device emulator coupled to the microcontroller, the device emulator having:
a plurality of endpoints, each endpoint:
corresponding to one of the functions of the emulated device; and
having at least one buffer to store the emulation information;
logic to perform low level emulation of at least one of the functions; and
a direct memory access (DMA) engine to transfer emulation information from the memory to the at least one buffer.

7. The system of claim 6, additionally comprising a network interface to receive the emulation information from a remote system.

8. The system of claim 7, additionally comprising a hub controller, and wherein the device emulator is internally coupled to the hub controller.

9. The system of claim 6, wherein each endpoint retrieves emulation information corresponding to the emulated device from a memory, and the device emulator additionally comprises data movement logic to move the emulation information from the memory to the at least one buffer.

10. The system of claim 6, wherein each endpoint additionally comprises at least one set of registers, and wherein the microcontroller uses the at least one set of registers to enable and disable the plurality of endpoints.

11. A method, comprising:
receiving emulation information at a processor, the emulation information corresponding to one or more functions of an emulated device, and the emulation information including at least one of data and commands; and
performing high level emulation of at least one of the plurality of functions in accordance with the emulation information, the emulation being performed by the processor;
transferring the emulation information from the processor to a device emulator; and
performing by the device emulator low level emulation of at least one of the functions.

12. The method of claim 11, wherein said transferring the emulation information from the processor to a device emulator comprises a direct memory access (DMA) engine transferring the emulation information from memory reserved for the processor to at least one buffer of the device emulator.

13. The method of claim 11, additionally comprising the processor using at least one set of registers associated with the device emulator to enable and disable the each endpoint associated with the device emulator.

14. An article of manufacture having stored thereon instructions, the instructions when executed by a machine, result in the following:
receiving emulation information at a processor, the emulation information corresponding to one or more functions of an emulated device, and the emulation information including at least one of data and commands; and
performing high level emulation of at least one of the plurality of functions in accordance with the emulation information, the emulation being performed by the processor;
transferring the emulation information from the processor to a device emulator; and
performing by the device emulator low level emulation of at least one of the functions.

15. The article of claim 14, wherein said instructions that result in transferring the emulation information from the processor to a device emulator comprises instructions that result in a direct memory access (DMA) engine transferring the emulation information from memory reserved for the processor to at least one buffer of the device emulator.

16. The article of claim 14, additionally comprising the processor using at least one set of registers associated with the device emulator to enable and disable the each endpoint associated with the device emulator.
